(19) United States
(12) Patent Application Publication
(10) Pub. No.: US 2024/0430719 A1
(43) Pub. Date: Dec. 26, 2024

(54) BAND ESTIMATING DEVICE AND BAND ESTIMATE METHOD

(71) Applicant: Panasonic Intellectual Property Management Co., Ltd., Kadoma-shi, Osaka (JP)

(72) Inventors: Takumi HIGUCHI, Kanagawa (JP); Tetsuro SATO, Tokyo (JP); Osamu TANAKA, Osaka (JP); Hiroaki ASANO, Kanagawa (JP)

(21) Appl. No.: 18/698,594

(22) PCT Filed: Sep. 1, 2022
(86) PCT No.: PCT/JP2022/032992

§ 371 Date: Apr. 4, 2024

(30) Foreign Application Priority Data
Oct. 8, 2021 (JP) 2021-166288

(51) Int. Cl. H04W 24/08; H04W 24/02

(52) U.S. Cl. CPC H04W 24/08; H04W 24/02

(57) ABSTRACT

A band estimating device according to an embodiment of the present disclosure comprises: a learning unit that trains, by real-time learning, a real-time learning model for estimating an available band of a radio communication path for a wireless communication performed by a terminal, and that trains, by pre-learning, a pre-learning model for estimating the available band of the wireless communication path using a parameter estimated by the real-time learning model and related to the wireless communication of the terminal; and an estimating unit that uses the pre-learning model to estimate the available band of the wireless communication path.

### TECHNICAL FIELD

The present disclosure relates to a bandwidth estimation apparatus and a method for estimating bandwidth.

### BACKGROUND ART

Compared to wired communication, mobile communication is prone to fluctuations in available bandwidth. A plurality of factors including network congestion, received power fluctuations, and handover between base stations causes such fluctuations in available bandwidth. Available bandwidth will also be simply referred to as bandwidth hereinafter.

When a transmission rate of data transmitted in mobile communication exceeds available bandwidth, a packet loss can occur, which might result in insufficient communication quality. It is therefore important to estimate available bandwidth of a radio communication channel, which is likely to fluctuate.

As a technique for estimating available bandwidth, for example, NPL 1 proposes a method in which a history of past throughput (i.e., available bandwidth) and a received signal strength indicator (RSSI) are learned through machine learning in order to perform bandwidth estimation. In this method, data for several to tens of minutes immediately before a time when bandwidth estimation is to be performed is learned, and future bandwidth estimation is achieved by reading a trend of fluctuations in available bandwidth on the basis of the learning.

### CITATION LIST

### Non-Patent Literature

NPL 1
B. Wei, W. Kawakami, K. Kanai, J. Katto, “Machine learning-based throughput prediction using communication quality in mobile networks,” IEICE Technical Report MoNA2017-53, vol. 117, no. 390, January 2018

### SUMMARY OF INVENTION

The method described in NPL 1, however, only learns data for several to tens of minutes immediately before a time when bandwidth estimation is to be performed, which leaves room for improvement in accuracy of bandwidth estimation.

Non-limiting embodiments of the present disclosure facilitate providing a bandwidth estimation apparatus and a method for estimating bandwidth capable of improving accuracy of bandwidth estimation.

A bandwidth estimation apparatus according to one example of the present disclosure includes: a trainer that trains, through real-time training, real-time-trained models for estimating an available bandwidth of a radio communication channel through which a terminal performs radio communication and that trains, through pre-training, pre-trained models for estimating the available bandwidth of the radio communication channel using a parameter relating to the radio communication performed by the terminal, the parameter being estimated from the real-time-trained models; and an estimator that estimates the available bandwidth of the radio communication channel using the pre-trained models.

A method for estimating bandwidth according to one example of the present disclosure includes: training, through real-time training, real-time-trained models for estimating an available bandwidth of a radio communication channel through which a terminal performs radio communication; training, through pre-training, pre-trained models for estimating the available bandwidth of the radio communication channel using a parameter relating to the radio communication performed by the terminal, the parameter being estimated from the real-time-trained models; and estimating the available bandwidth of the radio communication channel using the pre-trained models.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

According to the embodiments of the present disclosure, accuracy of bandwidth estimation can be improved.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a schematic block diagram illustrating an example of a communication system according to an embodiment of the present disclosure;

FIG. 2 is a schematic block diagram illustrating an example of functional configuration of a mobile terminal according to the embodiment of the present disclosure;

FIG. 3 is a schematic block diagram illustrating an example of functional configuration of a bandwidth estimation apparatus according to the embodiment of the present disclosure;

FIG. 4A is a diagram illustrating an example of pre-training performed in a pre-training phase according to the embodiment of the present disclosure;

FIG. 4B is a diagram illustrating another example of the pre-training performed in the pre-training phase according to the embodiment of the present disclosure;

FIG. 4C is a diagram illustrating yet another example of the pre-training performed in the pre-training phase according to the embodiment of the present disclosure;

FIG. 5A is a diagram illustrating an example of real-time training performed in a real-time training phase according to the embodiment of the present disclosure;

FIG. 5B is a diagram illustrating another example of the real-time training performed in the real-time training phase according to the embodiment of the present disclosure;

FIG. 5C is a diagram illustrating yet another example of the real-time training performed in the real-time training phase according to the embodiment of the present disclosure;

FIG. 5D is a diagram illustrating yet another example of the real-time training performed in the real-time training phase according to the embodiment of the present disclosure;

FIG. 5E is a diagram illustrating yet another example of the real-time training performed in the real-time training phase according to the embodiment of the present disclosure;

FIG. 6A is a diagram illustrating an example of bandwidth estimation performed in an estimation phase according to the embodiment of the present disclosure;

FIG. 6B is a diagram illustrating another example of the bandwidth estimation performed in the estimation phase according to the embodiment of the present disclosure;

FIG. 6C is a diagram illustrating yet another example of the bandwidth estimation performed in the estimation phase according to the embodiment of the present disclosure;

FIG. 6D is a diagram illustrating yet another example of the bandwidth estimation performed in the estimation phase according to the embodiment of the present disclosure;

FIG. 7 is a flowchart illustrating an example of operations for measuring data and transmitting the measured data according to the embodiment of the present disclosure;

FIG. 8 is a flowchart illustrating an example of operations for training and bandwidth estimation according to the embodiment of the present disclosure; and

FIG. 9 is a diagram illustrating an example of hardware configuration of a computer according to the embodiment of the present disclosure.

### DESCRIPTION OF EMBODIMENTS

Hereinafter, an embodiment of the present disclosure will be described in detail with reference to the accompanying drawings as appropriate. Having said that, a detailed description more than necessary may be omitted, such as a detailed description of an already well-known matter and a duplicated description for a substantially identical configuration, to avoid the following description becoming unnecessarily redundant and to facilitate understanding by those skilled in the art.

Note that, the accompanying drawings and the following description are provided for those skilled in the art to sufficiently understand the present disclosure, and are not intended to limit the subject matter described in the claims.

### Embodiment

### Communication System

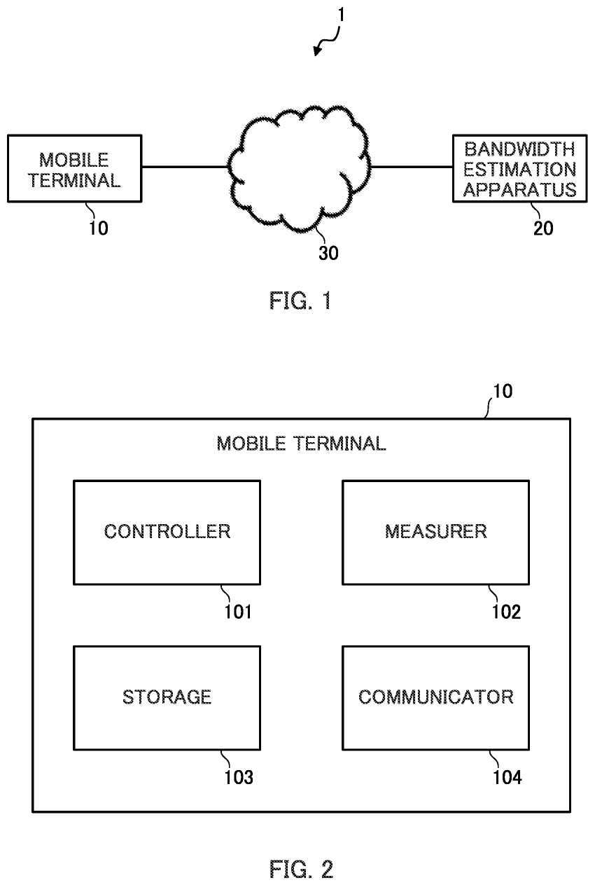

FIG. 1 is a schematic block diagram illustrating an example of communication system 1 according to an embodiment of the present disclosure. In FIG. 1, communication system 1 includes mobile terminal 10, bandwidth estimation apparatus 20, and network 30. Mobile terminal 10 and bandwidth estimation apparatus 20 are connected to each other over network 30.

Mobile terminal (may be simply referred to as a terminal) 10 may be, for example, a radio terminal such as a mobile phone, a smartphone, a tablet, a wearable device (e.g., includes a wristwatch (or wristband or ring) terminal, a head-mounted display (or glasses or goggles) terminal, an earphone terminal, a clothe terminal, a socks terminal, etc.), or a vehicle terminal (or an in-vehicle terminal). Mobile terminal 10 accesses network 30 including a mobile communication network using a communication method such as LTE, 5G, Beyond 5G, 6G, Wi-Fi (registered trademark), WiGig (registered trademark), or WiMax (registered trademark) and connects to bandwidth estimation apparatus 20 over network 30. Mobile terminal 10 transmits measured data measured by mobile terminal 10 and the like to bandwidth estimation apparatus 20.

Bandwidth estimation apparatus 20 may be, for example, an apparatus (e.g., a server apparatus) provided for a base station that communicates with mobile terminal 10. Bandwidth estimation apparatus 20 trains trained models for estimating available bandwidth of a radio communication channel in a radio communication system using measured data and the like received from mobile terminal 10 and estimates the available bandwidth using the trained models.

In LTE, 5G, and the like, available bandwidth can gradually or rapidly fluctuate. Factors contributing to gradual fluctuations in available bandwidth (hereinafter referred to as “gradual fluctuation factors”) are assumed to include changes in the number of users connecting to the same base station and distance attenuation of received power. Factors contributing to rapid fluctuations in available bandwidth (hereinafter referred to as “rapid fluctuation factors”), on the other hand, are assumed to include fading, shielding, and handovers. When available bandwidth rapidly fluctuates, it is difficult to estimate the available bandwidth using the method described in PTL 1, because the available bandwidth greatly changes before a trend in the fluctuation of the available bandwidth is grasped.

The rapid fluctuation factors relate to a location of a mobile terminal and a reception level (e.g., received power, received quality, etc.) of a radio signal received by the mobile terminal. In order to find the relationship, bandwidth estimation apparatus 20 learns how available bandwidth has fluctuated with different locations of the mobile terminal and different reception levels from a large amount of past data (so-called bigdata) and latest data. As a result, bandwidth estimation apparatus 20 can handle rapid fluctuations in the available bandwidth.

More specifically, bandwidth estimation apparatus 20 performs training and bandwidth estimation using the following two types of trained model.

First, bandwidth estimation apparatus 20 trains trained models in real-time mainly using latest data with a small number of samples for grasping a temporal trend. These trained models will be referred to as real-time-trained models, a stage where the real-time-trained models are trained will be referred to as a real-time training phase, and the training of the real-time-trained models will be referred to as real-time training herein. Bandwidth estimation apparatus 20 trains the real-time-trained models every time immediately before estimating available bandwidth. For example, bandwidth estimation apparatus 20 trains the real-time-trained models each time bandwidth estimation apparatus 20 performs the bandwidth estimation (e.g., every 1 second).

Second, bandwidth estimation apparatus 20 trains trained models in advance mainly using past data at every location with a large number of samples. These trained models will be referred to as pre-trained models, a stage where the pre-trained models are trained will be referred to as a pre-training phase, and the training of the pre-trained models will be referred to as pre-training herein. For example, bandwidth estimation apparatus 20 trains the pre-trained models at relatively long intervals, such as once an hour or once a day.

Bandwidth estimation apparatus 20 then performs the bandwidth estimation in real-time using the real-time-trained models and the pre-trained models. A stage where the bandwidth estimation is performed will be referred to as an estimation phase herein.

Bandwidth estimation apparatus 20 can thus estimate, using the real-time-trained models and the pre-trained models, both available bandwidth that fluctuates gradually with respect to time and available bandwidth that fluctuates rapidly with respect to time.

Network 30 may include, for example, a radio communication network or a wired communication network such as the above-described mobile communication network or the Internet.

### Mobile Terminal

Next, an example of configuration of mobile terminal 10 will be described with reference to FIG. 2. FIG. 2 is a schematic block diagram illustrating functional configuration of mobile terminal 10 according to the embodiment of the present disclosure.

As illustrated in FIG. 2, mobile terminal 10 includes controller 101, measurer 102, storage 103, and communicator 104.

Controller 101 controls overall operation of mobile terminal 10. For example, controller 101 instructs measurer 102 to measure data to be used by bandwidth estimation apparatus 20 for training and store the measured data in storage 103. Controller 101 also instructs, for example, communicator 104 to read the measured data stored in storage 103 and transmit the measured data to bandwidth estimation apparatus 20.

Measurer 102 measures data to be used by bandwidth estimation apparatus 20 for training. For example, measurer 102 measures received power and received quality of a radio signal received from another communication apparatus such as a base station. Measurer 102 also measures, for example, a location, such as latitude and longitude, of mobile terminal 10 at a time when the radio signal is received. Measurer 102 also measures, for example, throughput at a time when the radio signal is received. Measurer 102 stores the measured data including the measured received power and received quality, the measured latitude and longitude, or the measured throughput in storage 103 in association with a measurement time (e.g., a measurement time at which the received power and the received quality were measured, a measurement time at which the latitude and the longitude were measured, and a measurement time at which the throughput was measured). The following table 1 indicates an example of the measured data. Received power and received quality in the present embodiment shown in the following table 1 are RSRP (reference signal received power) and RSRQ (reference signal received quality), respectively, but the present disclosure is not limited to these. For example, received power may be RSSI or the like, and received quality may be SIR (signal-to-interference ratio) or the like, instead.

### Table 1

TABLE 1

| | | Throughput | | | | |
|---|---|---|---|---|---|---|
| Measured | Measurement | (available | | | Received | Received |
| data ID | time | bandwidth) | Latitude | Longitude | power | quality |
| 1 | 11:00:00 | 50 Mbps | 35.5123 | 139.5633 | −98 dB | −14 dB |
| 2 | 11:00:01 | 53 Mbps | 35.5119 | 139.5634 | −97 dB | −15 dB |
| 3 | 11:00:02 | 55 Mbps | 35.5115 | 139.5635 | −95 dB | −13 dB |

Storage 103 stores data necessary for mobile terminal 10 to operate, measured data measured by measurer 102, and the like.

Communicator 104 communicates radio signals with other communication apparatuses such as base stations over network 30. Communicator 104 also transmits measured data and measurement times stored in storage 103 and identification information (ID) for identifying mobile terminal 10 to bandwidth estimation apparatus 20 over network 30.

### Bandwidth Estimation Apparatus

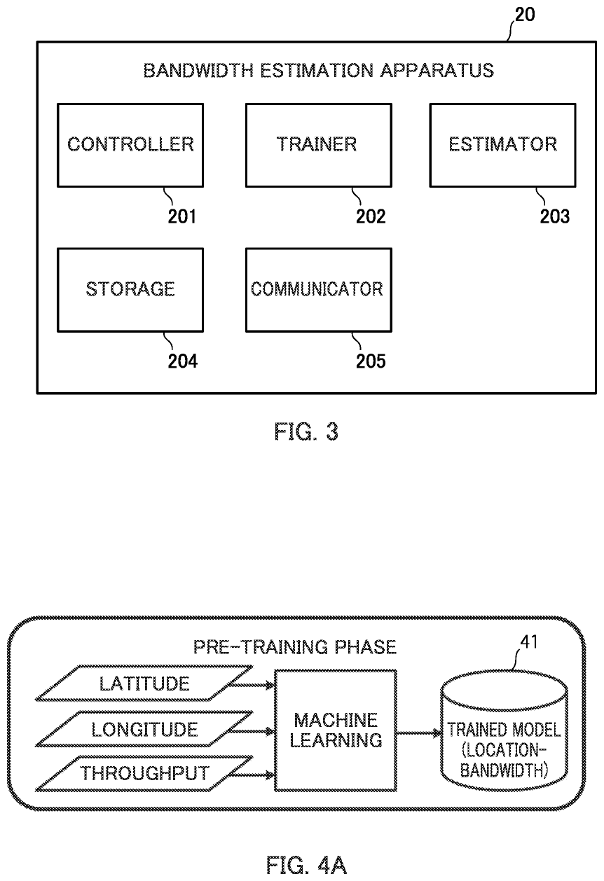

Next, an example of configuration of bandwidth estimation apparatus 20 will be described with reference to FIG. 3. FIG. 3 is a schematic block diagram illustrating an example of functional configuration of bandwidth estimation apparatus 20 according to the embodiment of the present disclosure.

As illustrated in FIG. 3, bandwidth estimation apparatus 20 includes controller 201, trainer 202, estimator 203, storage 204, and communicator 205.

Controller 201 controls overall operation of bandwidth estimation apparatus 20. For example, controller 201 reads measured data received from mobile terminal 10 and stored in storage 204, trained models stored in storage 204, and the like and instructs trainer 202 to perform training using these. Controller 201 also instructs, for example, estimator 203 to read the trained models stored in storage 204, perform bandwidth estimation using the trained models, and store a result of the estimation (estimated available bandwidth) in storage 204. Controller 201 also instructs, for example, communicator 205 to store measured data received from mobile terminal 10 and the like in storage 204.

Trainer 202 performs, using measured data received from mobile terminal 10 and stored in storage 204 and the like, training for estimating available bandwidth of a radio communication channel used by mobile terminal 10 for radio communication. For example, trainer 202 creates (or updates) (trains) the above-described pre-trained model and real-time-trained model, and stores the trained pre-trained model and real-time-trained model in storage 204. Details of the operation of trainer 202 will be described later.

Estimator 203 performs bandwidth estimation using the trained models stored in storage 204. For example, estimator 203 performs the bandwidth estimation using the pre-trained model and the real-time-trained model trained by trainer 202 and stores a result of the bandwidth estimation in storage 204. Details of the operation of estimator 203 will be described later.

Storage 204 stores data necessary for bandwidth estimation apparatus 20 to operate, data used by trainer 202 to train the pre-trained model and the real-time-trained model (measured data received from mobile terminal 10 and the like), the pre-trained model and the real-time-trained model trained by trainer 202, a result of bandwidth estimation performed by estimator 203, and the like.

Communicator 205 receives measured data transmitted from mobile terminal 10 and the like over network 30, for example, and stores the received measured data and the like in storage 103.

### Details of Training

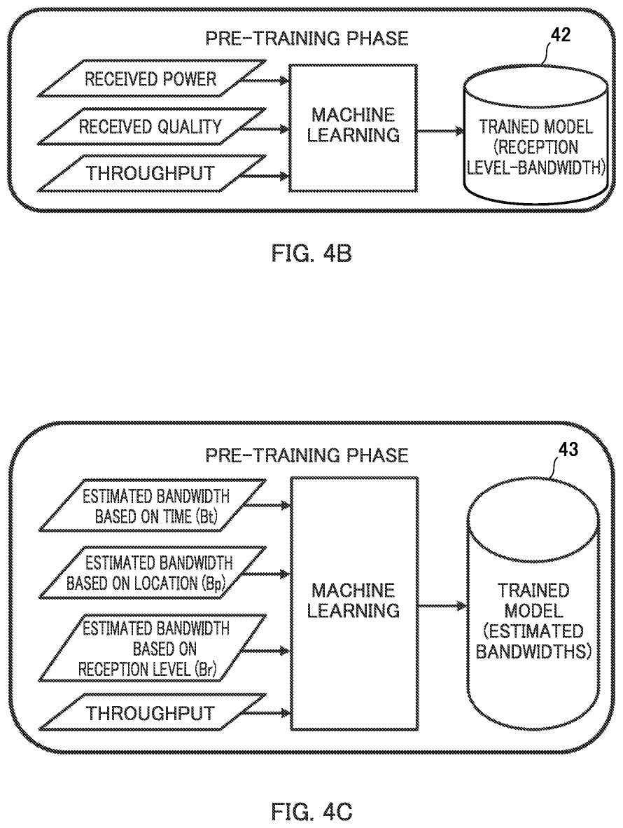

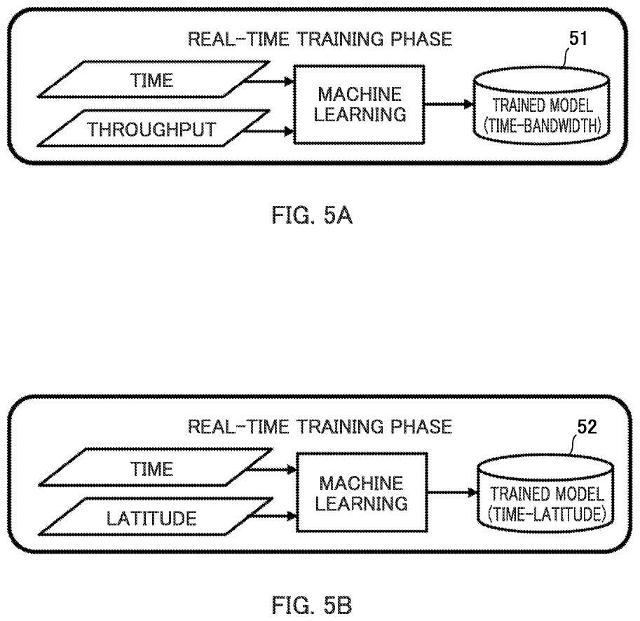

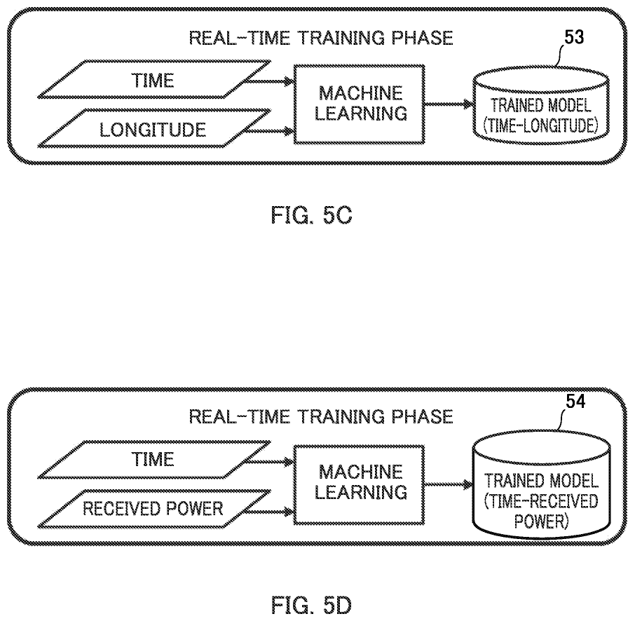

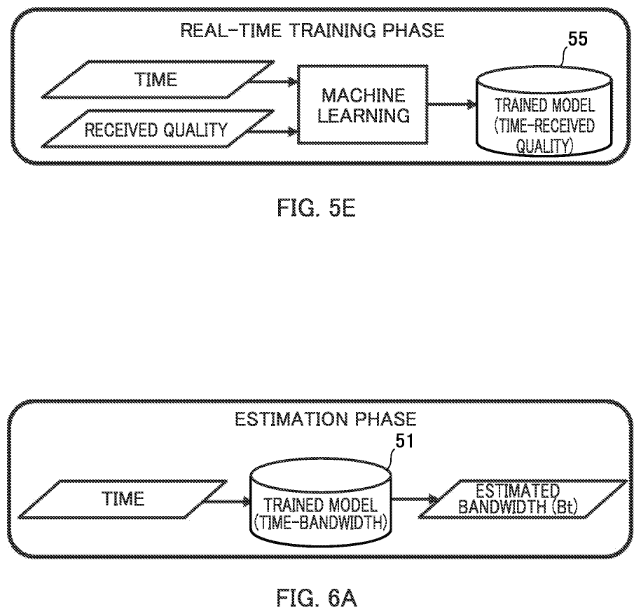

Next, the training performed by trainer 202 will be described with reference to FIGS. 4A to 5E.

### Pre-Training Phase

FIG. 4A is a diagram illustrating an example of pre-training performed in the pre-training phase according to the embodiment of the present disclosure. A pre-trained model illustrated in FIG. 4A is a trained model where the location of mobile terminal 10 and available bandwidth of a radio communication channel are associated with each other (hereinafter referred to as trained model (location-bandwidth) 41).

Trainer 202 trains trained model (location-bandwidth) 41 by performing machine learning (e.g., through SVR (support vector regression)) using latitude and longitude, which are measured data, transmitted from mobile terminal 10 as input data and throughput at a time when mobile terminal 10 was at located at the latitude and the longitude as a label.

FIG. 4B is a diagram illustrating another example of the pre-training performed in the pre-training phase according to the embodiment of the present disclosure. A pre-trained model illustrated in FIG. 4B is a trained model where the reception level of mobile terminal 10 and available bandwidth of a radio communication channel are associated with each other (hereinafter referred to as trained model (reception level-bandwidth) 42).

Trainer 202 trains trained model (reception level-bandwidth) 42 by performing machine learning using received power and received quality, which are measured data, transmitted from mobile terminal 10 as input data and throughput at a time when the received power and the received quality were obtained as a label.

FIG. 4C is a diagram illustrating yet another example of the pre-training performed in the pre-training phase according to the embodiment of the present disclosure. A pre-trained model illustrated in FIG. 4C is a trained model where a plurality of estimated bandwidths including estimated bandwidth Bt based on time, estimated bandwidth Bp based on location, and estimated bandwidth Br based on reception level, which will be described hereinafter with respect to the details of the operation of estimator 203, and available bandwidth of a radio communication channel are associated with each other (hereinafter referred to as trained model (estimated bandwidths) 43).

Trainer 202 trains trained model (estimated bandwidths) 43 by performing machine learning using estimated bandwidth Bt, estimated bandwidth Bp, and estimated bandwidth Br as input data and throughput at a measurement time at which these estimated bandwidths were estimated as a label.

Trainer 202 may perform these types of pre-training sequentially or in parallel with one another.

Trained model (location-bandwidth) 41, trained model (reception level-bandwidth) 42, and trained model (estimated bandwidths) 43 are examples of a first pre-trained model, a second pre-trained model, and a third pre-trained model, respectively, in the present disclosure.

### Real-Time Training Phase

FIG. 5A is a diagram illustrating an example of real-time training performed in the real-time training phase according to the embodiment of the present disclosure. A real-time-trained model illustrated in FIG. 5A is a trained model where time and available bandwidth of a radio communication channel are associated with each other (hereinafter referred to as trained model (time-bandwidth) 51).

Trainer 202 trains trained model (time-bandwidth) 51 by performing machine learning using a period of time (e.g., past several to tens of minutes) as input data and throughput of mobile terminal 10 in the period of time as a label.

FIG. 5B is a diagram illustrating another example of the real-time training in the real-time training phase according to the embodiment of the present disclosure. A real-time-trained model illustrated in FIG. 5B is a trained model where time and latitude are associated with each other (hereinafter referred to as trained model (time-latitude) 52).

Trainer 202 trains trained model (time-latitude) 52 by performing machine learning using a period of time (e.g., past several to tens of minutes) as input data and latitude of mobile terminal 10 in the period of time as a label.

FIG. 5C is a diagram illustrating yet another example of the real-time training performed in the real-time training phase according to the embodiment of the present disclosure. A real-time-trained model illustrated in FIG. 5C is a trained model where time and longitude are associated with each other (hereinafter referred to as trained model (time-longitude) 53).

Trainer 202 trains trained model (time-longitude) 53 by performing machine learning using a period of time (e.g., past several to tens of minutes) as input data and longitude of mobile terminal 10 in the period of time as a label.

FIG. 5D is a diagram illustrating yet another example of the real-time training performed in the real-time training phase according to the embodiment of the present disclosure. A real-time-trained model illustrated in FIG. 5D is a trained model where time and received power are associated with each other (hereinafter referred to as trained model (time-received power) 54).

Trainer 202 trains trained model (time-received power) 54 by performing machine learning using a period of time (e.g., past several to tens of minutes) as input data and received power of mobile terminal 10 in the period of time as a label.

FIG. 5E is a diagram illustrating yet another example of the real-time training performed in the real-time training phase according to the embodiment of the present disclosure. A real-time-trained model illustrated in FIG. 5E is a trained model where time and received quality are associated with each other (hereinafter referred to as trained model (time-received quality) 55).

Trainer 202 trains trained model (time-received quality) 55 by performing machine learning using a period of time (e.g., past several to tens of minutes) as input data and received quality of mobile terminal 10 in the period of time as a label.

Trainer 202 may perform these types of real-time training sequentially or in parallel with one another.

Trained model (time-latitude) 52 and trained model (time-longitude) 53, trained model (time-received power) 54 and trained model (time-received quality) 55, and trained model (time-bandwidth) 51 are examples of a first real-time-trained model, a second real-time-trained model, and third real-time-trained model, respectively, in the present disclosure.

### Details of Bandwidth Estimation

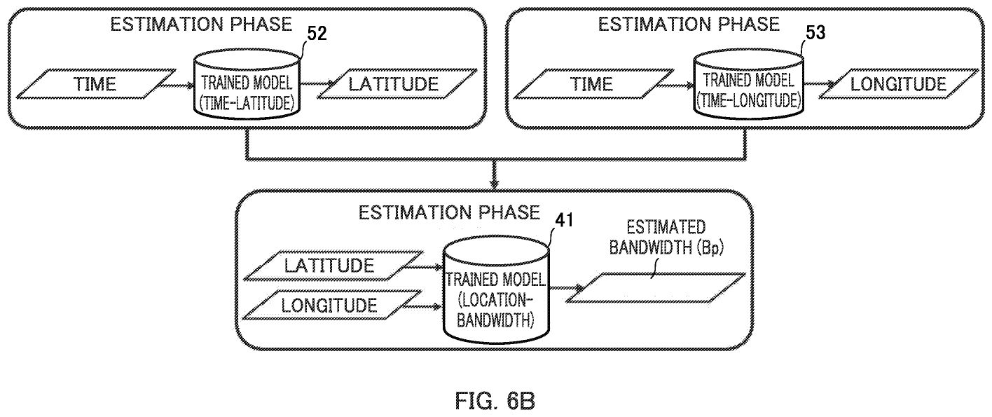

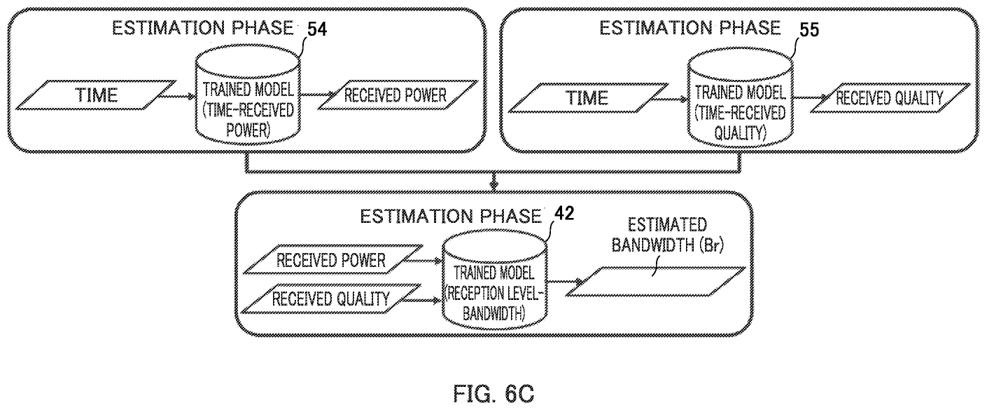

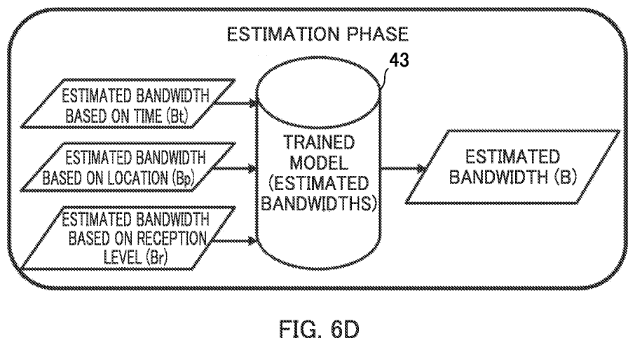

Next, the bandwidth estimation performed by estimator 203 will be described with reference to FIGS. 6A to 6D.

FIG. 6A is a diagram illustrating an example of bandwidth estimation performed in the estimation phase according to the embodiment of the present disclosure. In the bandwidth estimation illustrated in FIG. 6A, estimator 203 inputs a time to trained model (time-bandwidth) 51 to cause trained model (time-bandwidth) 51 to output estimated bandwidth Bt based on the time as a result of the estimation.

FIG. 6B is a diagram illustrating yet another example of the bandwidth estimation performed in the estimation phase according to the embodiment of the present disclosure. The bandwidth estimation illustrated in FIG. 6B includes three stages.

In a first stage, estimator 203 inputs a time to trained model (time-latitude) 52 to cause trained model (time-latitude) 52 to output latitude of mobile terminal 10 at the time as a result of the estimation.

In a second stage, estimator 203 inputs a time to trained model (time-longitude) 53 to cause trained model (time-longitude) 53 to output longitude of mobile terminal 10 at the time as a result of the estimation. Order in which the first and second stages are performed may be reversed, or the first and second stages may be performed in parallel with each other, instead.

Lastly, at a third stage, estimator 203 inputs the latitude and the longitude output in the first and second stages, respectively, to trained model (location-bandwidth) 41 to cause trained model (location-bandwidth) 41 to output estimated bandwidth Bp based on the latitude and the longitude (location) of mobile terminal 10 as a result of the estimation.

FIG. 6C is a diagram illustrating yet another example of the bandwidth estimation performed in the estimation phase according to the embodiment of the present disclosure. The bandwidth estimation illustrated in FIG. 6C, too, includes three stages.

In a first stage, estimator 203 inputs a time to trained model (time-received power) 54 to cause trained model (time-received power) 54 to output received power with which mobile terminal 10 receives a radio signal at the time as a result of the estimation.

In a second stage, estimator 203 inputs a time to trained model (time-received quality) 55 to cause trained model (time-received quality) 55 to output received quality with which mobile terminal 10 receives a radio signal at the time as a result of the estimation. Order in which the first and second stages are performed may be reversed, or the first and second stages may be performed in parallel with each other, instead.

Lastly, in a third stage, estimator 203 inputs the received power and the received quality output in the first and second stages, respectively, to trained model (reception level-bandwidth) 42 to cause trained model (reception level-bandwidth) 42 to output estimated bandwidth Br based on the received power and the received quality (reception level) of mobile terminal 10 as a result of the estimation.

FIG. 6D is a diagram illustrating yet another example of the bandwidth estimation performed in the estimation phase according to the embodiment of the present disclosure. In the bandwidth estimation illustrated in FIG. 6D, estimator 203 inputs estimated bandwidth Bt based on time, estimated bandwidth Bp based on location, and estimated bandwidth Br based on reception level to trained model (estimated bandwidths) 43 to cause trained model (estimated bandwidths) 43 to output estimated bandwidth B based on time, location, and reception level as a result of the estimation.

Estimator 203 may perform the types of bandwidth estimation illustrated in FIGS. 6A to 6C sequentially or in parallel with one another. Estimator 203 may then perform the bandwidth estimation illustrated in FIG. 6D.

It is to be noted that the location and the reception level of mobile terminal 10 are examples of parameters of a terminal relating to radio communication estimated from the real-time-trained model (e.g., trained model (time-latitude) 52, trained model (time-longitude) 53, trained model (time-received power) 54, or trained model (time-received quality) 55).

### Operation Flow of Measurement of Data and Transmission of Measured Data

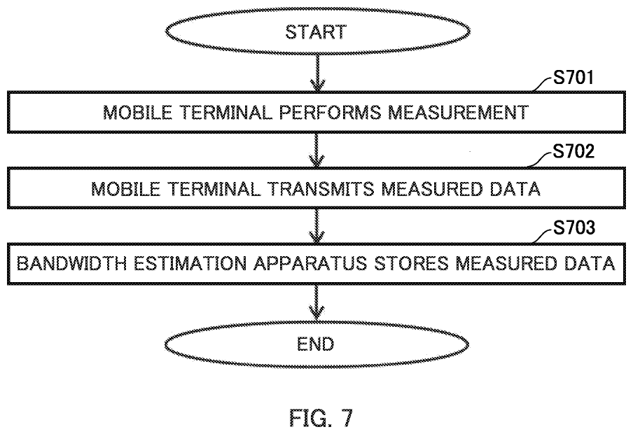

Next, an operation flow of measurement of data and transmission of the measured data will be described with reference to FIG. 7. FIG. 7 is a flowchart illustrating an example of operations for measuring data and transmitting the measured data according to the embodiment of the present disclosure.

In step S701, mobile terminal 10 measures a location (latitude and longitude), a reception level (received power and received quality), and through put at a time when a radio signal is received and stores the measured data in storage 103 in association with a measurement time.

In step S702, mobile terminal 10 transmits the stored measured data and measurement time and the ID of mobile terminal 10 to bandwidth estimation apparatus 20. It is to be noted that step S702 may be performed immediately after step S702 or at certain intervals. When step S702 is performed at certain intervals, measured data measured after measured data transmitted from mobile terminal 10 in a previous interval and the like may be collectively transmitted to bandwidth estimation apparatus 20 in a next interval.

In step S703, bandwidth estimation apparatus 20 stores the received measured data and the like in storage 204.

### Operation Flow of Training and Bandwidth Estimation

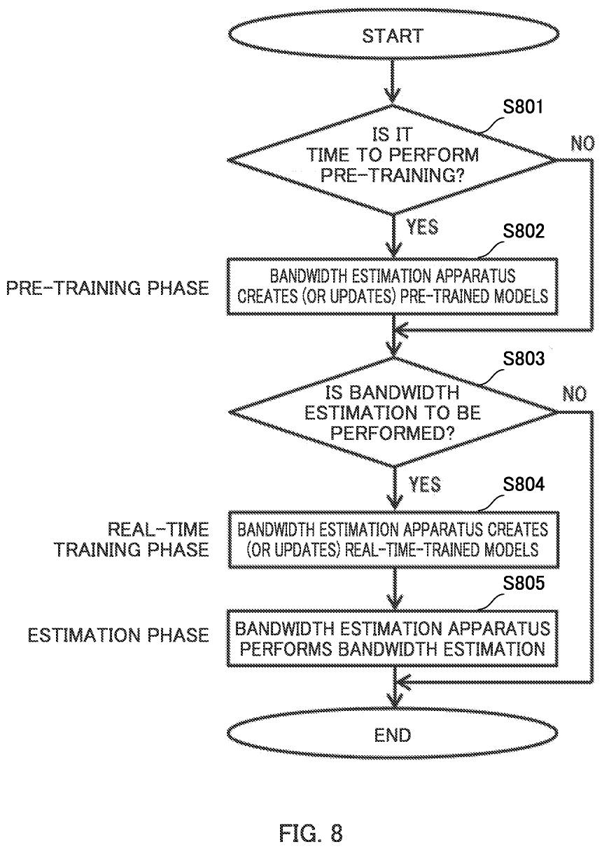

Next, an operation flow of training and bandwidth estimation will be described with reference to FIG. 8. FIG. 8 is a flowchart illustrating an example of operations for training and bandwidth estimation according to the embodiment of the present disclosure.

In step S801, bandwidth estimation apparatus 20 determines whether a time to perform pre-training has come. As described above, bandwidth estimation apparatus 20 may perform pre-training at relatively long intervals, such as once an hour or once a day.

When a time to perform pre-training has come (YES in step S801), bandwidth estimation apparatus 20 creates (or updates) (trains), in step S802 (pre-training phase), pre-trained models using measured data and the like stored in storage 204 and stores the pre-trained models in storage 204. The pre-trained models to be trained may include trained model (location-bandwidth) 41, trained model (reception level-bandwidth) 42, and trained model (estimated bandwidths) 43. Initial training of trained model (estimated bandwidths) 43 is delayed from initial training of trained model (location-bandwidth) 41 and trained model (reception level-bandwidth) 42. When a time to perform pre-training has not come (NO in step S801), on the other hand, the process proceeds to step S803.

In step S803, bandwidth estimation apparatus 20 determines whether to perform bandwidth estimation. For example, the bandwidth estimation is performed at regular intervals or in response to a request to perform bandwidth estimation from another process performed by bandwidth estimation apparatus 20 or an apparatus other than bandwidth estimation apparatus 20.

When bandwidth estimation is to be performed (YES in step S803), bandwidth estimation apparatus 20 creates (or updates) (trains), in step S804 (real-time training phase), real-time-trained models and stores the real-time-trained models in storage 204. The real-time-trained model to be trained may include trained model (time-bandwidth) 51, trained model (time-latitude) 52, trained model (time-longitude) 53, trained model (time-received power) 54, and trained model (time-received quality) 55. When bandwidth estimation is not to be performed (NO in step S803), on the other hand, the process ends.

After step S804, bandwidth estimation apparatus 20 reads, in step S805 (estimation phase), the trained models stored in storage 204, performs the bandwidth estimation as described with reference to FIGS. 6A to 6D using the trained models, and stores results of the estimation in storage 204. Initial estimation based on trained model (estimated bandwidths) 43 is delayed from initial estimation based on trained model (location-bandwidth) 41 and trained model (reception level-bandwidth) 42. After step S805, the process ends.

The process illustrated in FIG. 8 is performed repeatedly (e.g., every 0.5 second, every 1 second, etc.) for a certain period of time (e.g., when a video is streamed, a period for which the video is streamed).

It is to be noted that at least estimated bandwidth Bt, estimated bandwidth Bp, estimated bandwidth Br, or estimated bandwidth B, for example, may be used for another process (e.g., a process for compressing video data in accordance with available bandwidth) or another apparatus later. When a plurality of estimated bandwidths is used among these, for example, a result obtained by averaging or weighted averaging the plurality of estimated bandwidths may be used as an input for another process.

It is noted that although an example where a relationship between location and radio wave quality is learned and bandwidth is predicted has been described, a relationship between time (includes a date, a time, and a day) information and radio wave quality may be learned in addition to positional information, instead. It is possible, for example, to learn a tendency for more people to gather in a restaurant area of an office district during lunch time, which increases bandwidth usage, and use this information to estimate bandwidth. Time-based bandwidth estimation can be performed on the basis of differences between weekends and weekdays and hours of the day, such as morning, afternoon, or night.

Furthermore, bandwidth estimation may be performed while also taking into consideration information regarding a date of an event or the like. By using information regarding locations, times, and dates of gatherings of people for baseball, soccer, tennis, concerts, outdoor festivals, and the like and collecting and training, as big data, information regarding radio wave quality at similar events in past on the basis of size of gatherings (the number of people etc.), for example, radio wave quality in near future (or several days or weeks ahead) can be created in advance as training data and used for the bandwidth estimation in the present disclosure.

Furthermore, on large roads with heavy traffic, radio wave quality might change due to interference by vehicles and other factors caused by the traffic volume. For example, shielding by large vehicles such as trucks might reduce strength of received radio waves. In this case, a relationship between a degree of vehicle congestion on roads and radio wave quality may be learned in advance using information from surveillance cameras and the like installed along the roads and used for the bandwidth estimation. Alternatively, radio wave quality may be learned in advance in such a way as to associate congestion information and positional information obtained from VICS (registered trademark; a road traffic information and communication system) with each other and used for the bandwidth estimation.

Furthermore, with respect to the relationship between traffic volume and radio wave quality, congestion might occur on the 5th, 10th, and other days of each month with a number 5 or 10. In addition, during late night hours, traffic volume might increase or there might be an increase in large vehicles, such as trucks, that cause shielding of radio waves on some roads. In such cases, too, radio wave quality may be learned in advance in such a way as to associate time information, positional information, and information regarding road conditions and the like with one another and used for the bandwidth estimation.

Furthermore, radio wave quality might be affected by shielding by a person holding a mobile terminal. Radio wave quality might vary depending on whether there is a person between a base station and a mobile terminal. In such a case, too, the bandwidth estimation can be performed while adding information regarding a traveling direction to data used for the training in the real-time training phase by obtaining the traveling direction using an acceleration sensor provided for a mobile terminal. In addition, when an orientation sensor (a sensor that detects east, north, west, south, and the like) is provided for a mobile terminal, radio wave quality can be predicted, that is, the bandwidth estimation can be performed, by adding orientation information indicating whether the mobile terminal is oriented in a direction of a base station to the data used for the training in the real-time training phase. Directions of base stations may be accumulated in advance in the pre-training phase in coordination with information such as map information.

Furthermore, outputs obtained from NWDAF (network data analytics function) may be used as data to be input to a trained model. The NWDAF is one of functions included in an architecture specified by 3GPP TS 23.501 Release 16, which is a 5G international standard. The NWDAF has a function of collecting information from each NF (network function), AF (application function), OAM (operation, administration, and management), and the like in a 5G core network, gathering past statistics from the information, and predicting a future network state. The outputs of the NWDAF include, for example, an estimated value of the amount of data communicated and estimated service quality of audiovisual streaming.

Although an example where mobile terminal 10 measures data to be used for training (throughput, a location, and a reception level) has been described in the above embodiment, the present disclosure is not limited to this example. For example, a base station that communicates with mobile terminal 10 or both mobile terminal 10 and the base station may measure data to be used for training, instead. In this case, as in the above case, the data measured by the base station or both mobile terminal 10 and the base station is aggregated to bandwidth estimation apparatus 20.

In addition, although an example where bandwidth estimation apparatus 20 is provided for a base station has been described in the above embodiment, the present disclosure is not limited to this example. For example, bandwidth estimation apparatus 20 may be a mobile terminal such as mobile terminal 10 or an information processing apparatus (e.g., a server apparatus) such as a computer separate from an apparatus provided for a base station or a mobile terminal, instead. It is to be noted that when an apparatus that measures data to be used for training and an apparatus that performs bandwidth estimation are different from each other, the measured data is shared between these apparatuses as in the above case. By separating an apparatus that measures data to be used for training and an apparatus that performs bandwidth estimation from each other like this, processing with a large load (bandwidth estimation) can be assigned to a fixed high-performance apparatus (e.g., a server apparatus).

Further, any component termed with a suffix, such as “-er,” “-or,” or “-ar” in the present disclosure may be replaced with another term such as “circuit (circuitry),” “assembly,” “device,” “unit,” or “module.”

Although an embodiment of the present disclosure has been described in detail with reference to the drawings, the above-described functions of bandwidth estimation apparatus 20 may be achieved by a computer program, instead.

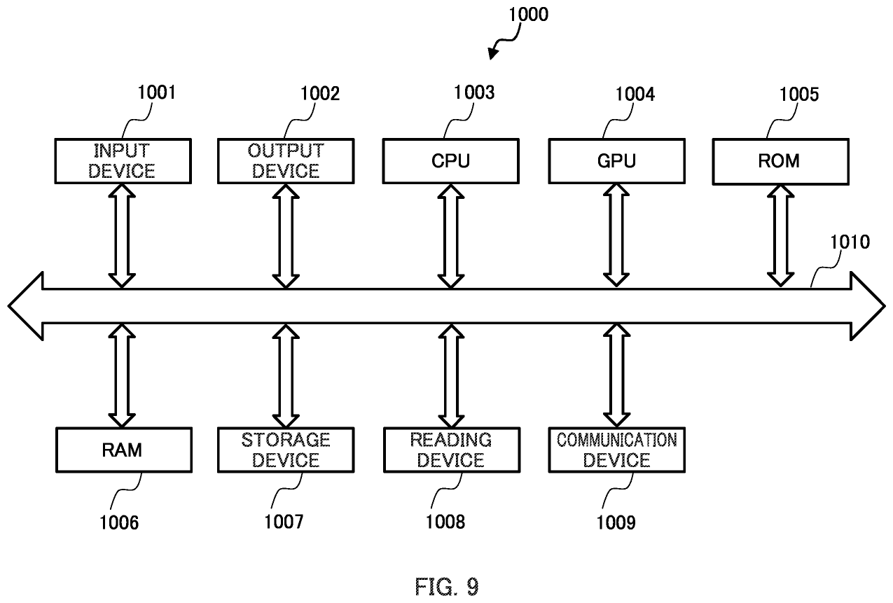

FIG. 9 is a diagram illustrating hardware configuration of a computer that achieves the functions of bandwidth estimation apparatus 20 with a program. This computer 1000 includes input device 1001 such as a keyboard, a mouse, or a touchpad, output device 1002 such as a display or a speaker, CPU (central processing unit) 1003, GPU (graphics processing unit) 1004, ROM (read-only memory) 1005, RAM (random-access memory) 1006, a storage device 1007 such as a hard disk device or an SSD (solid state drive), a reading device 1008 that reads information from a storage medium such as a DVD-ROM (digital versatile disk read-only memory) or a USB (universal serial bus) memory, and a communication device 1009 that performs communication over a network. These devices 1001 to 1009 are connected to one another through a bus 1010.

Reading device 1008 reads a program for achieving the functions of bandwidth estimation apparatus 20 from a storage medium storing the program and stores the program in storage device 1007. Alternatively, communication device 1009 communicates with a server apparatus connected to the network and stores, in storage device 1007, a program for achieving the functions of bandwidth estimation apparatus 20 downloaded from the server apparatus.

CPU 1003 then copies the program stored in storage device 1007 to RAM 1006, sequentially reads instructions included in the program from RAM 1006, and executes the instructions to achieve the functions of bandwidth estimation apparatus 20.

### Effects Produced in Embodiment

Bandwidth estimation apparatus 20 according to the embodiment of the present disclosure includes trainer 202 that trains, through real-time training, real-time-trained models 51 to 55 for estimating available bandwidth of a radio communication channel through which mobile terminal 10 performs radio communication and that trains, through pre-training, pre-trained models 41 to 43 for estimating the available bandwidth of the radio communication channel using parameters (the location and the reception level) relating to the radio communication performed by mobile terminal 10, the parameters being estimated from real-time-trained models 52 to 55, and estimator 203 that estimates the available bandwidth of the radio communication channel using pre-trained models 41 and 42. With this configuration, trainer 202 can train pre-trained models 41 and 42 at relatively long intervals, such as once an hour or once a day, using past data at every location with a large number of samples and improve accuracy of the bandwidth estimation. In addition, the bandwidth estimation can be performed in real-time using real-time-trained models 52 to 55.

In bandwidth estimation apparatus 20, trainer 202 trains, through pre-training, first pre-trained model 41 included in pre-trained models 41 to 43, first pre-trained model 41 associating the location (latitude and longitude) of mobile terminal 10 and the available bandwidth of the radio communication channel with each other, and estimator 203 estimates the available bandwidth of the radio communication channel using first pre-trained model 41. With this configuration, since pre-trained model 41 that associates the location of mobile terminal 10, which relates to the rapid fluctuation factors, and the available bandwidth with each other is trained, rapid fluctuations in the available bandwidth can be handled.

In bandwidth estimation apparatus 20, trainer 202 trains, through pre-training, second pre-trained model 42 included in pre-trained models 41 to 43, second pre-trained model 42 associating the reception level (received power and received quality) of mobile terminal 10 and the available bandwidth of the radio communication channel with each other, and estimator 203 estimates the available bandwidth of the radio communication channel using second pre-trained model 42. With this configuration, since pre-trained model 42 that associates the reception level of mobile terminal 10, which relates to the rapid fluctuation factors, and the available bandwidth with each other is trained, rapid fluctuations in the available bandwidth can be handled.

In bandwidth estimation apparatus 20, trainer 202 trains, through real-time training, first real-time-trained models 52 and 53 included in real-time-trained models 51 to 55, first real-time-trained models 52 and 53 associating time and the location of mobile terminal 10 with each other, and estimator 203 estimates the location of mobile terminal 10 using first real-time-trained models 52 and 53 and then estimates the available bandwidth of the radio communication channel using the estimated location and first pre-trained model 41. With this configuration, since pre-trained model 41 that associates the location of mobile terminal 10, which relates to the rapid fluctuation factors, and the available bandwidth with each other is trained, rapid fluctuations in the available bandwidth can be handled.

In bandwidth estimation apparatus 20, trainer 202 trains, through real-time training, second real-time-trained models 54 and 55 included in real-time-trained models 51 to 55, second real-time-trained models 54 and 55 associating time and the reception level of mobile terminal 10 with each other, and estimator 203 estimates the reception level of mobile terminal 10 using second real-time-trained models 54 and 55 and then estimates the available bandwidth of the radio communication channel using the estimated reception level and second pre-trained model 42. With this configuration, since pre-trained model 42 that associates the reception level of mobile terminal 10, which relates to the rapid fluctuation factors, and the available bandwidth with each other is trained, rapid fluctuations in the available bandwidth can be handled.

In bandwidth estimation apparatus 20, trainer 202 trains, through pre-training, first pre-trained model 41 included in pre-trained models 41 to 43, first pre-trained model 41 associating the location of mobile terminal 10 and the available bandwidth of the radio communication channel with each other, and second pre-trained model 42 included in pre-trained models 41 to 43, second pre-trained model 42 associating the reception level of mobile terminal 10 and the available bandwidth of the radio communication channel with each other, and trains, through real-time training, third real-time-trained model 51 included in real-time-trained models 51 to 55, third real-time-trained model 51 associating time and the available bandwidth of the radio communication channel with each other, estimator 203 estimates the available bandwidth of the radio communication channel using first pre-trained model 41, estimates the available bandwidth of the radio communication channel using second pre-trained model 42, and estimates the available bandwidth of the radio communication channel using third real-time-trained model 51, trainer 202 trains, through pre-training, third pre-trained model 43 included in pre-trained models 41 to 43, third pre-trained model 43 associating available bandwidth Bt estimated using third real-time-trained model 51, available bandwidth Bp estimated using first pre-trained model 41, and available bandwidth Br estimated using second pre-trained model 42 and the available bandwidth of the radio communication channel with each other, and estimator 203 estimates the available bandwidth of the radio communication channel using third pre-trained model 43. With this configuration, trainer 202 can train pre-trained model 43 at relatively long intervals, such as once an hour or once a day, using estimated bandwidth Bt, estimated bandwidth Bp, and estimated bandwidth Br of mobile terminal 10 at every location with a large number of samples and further improve the accuracy of the bandwidth estimation. Furthermore, since pre-trained model 41 that associates the location of mobile terminal 10, which relates to the rapid fluctuation factors, and the available bandwidth with each other and pre-trained model 42 that associates the reception level of mobile terminal 10, which relates to the rapid fluctuation factors, and the available bandwidth with each other are trained, rapid fluctuations in the available bandwidth can be handled.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

When future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

Although the embodiments have been described above with reference to the accompanying drawings, the present disclosure is not limited to such examples. It is obvious that a person skilled in the art can arrive at various variations and modifications within the scope described in the claims. It is understood that such variations and modifications also belong to the technical scope of the present disclosure as a matter of fact. Further, components in the embodiments described above may be arbitrarily combined without departing from the spirit of the present disclosure.

Further, the specific examples in the present disclosure are merely exemplary and do not limit the scope of the claims. The techniques described in the scope of the claims include various variations and modifications of the specific examples exemplified above.

The entire contents disclosed in the specification, drawings, and abstract contained in the Japanese Patent Application No. 2021-166288, filed Oct. 8, 2021, are incorporated herein by reference.

An embodiment of the present disclosure is useful for radio communication systems.

### REFERENCE SIGNS LIST

1 communication system
10 mobile terminal
101 controller
102 measurer
103 storage
104 communicator
20 bandwidth estimation apparatus
201 controller
202 trainer
203 estimator
204 storage
205 communicator
41 trained model (location-bandwidth)
42 trained model (reception level-bandwidth)
43 trained model (estimated bandwidths)
51 trained model (time-bandwidth)
52 trained model (time-latitude)
53 trained model (time-longitude)
54 trained model (time-received power)
55 trained model (time-received quality)

1. A bandwidth estimation apparatus, comprising:
a trainer that trains, through real-time training, real-time-trained models for estimating an available bandwidth of a radio communication channel through which a terminal performs radio communication and that trains, through pre-training, pre-trained models for estimating the available bandwidth of the radio communication channel using a parameter relating to the radio communication performed by the terminal, the parameter being estimated from the real-time-trained models; and
an estimator that estimates the available bandwidth of the radio communication channel using the pre-trained models.

2. The bandwidth estimation apparatus according to claim 1,
wherein the trainer trains, through the pre-training, a first pre-trained model included in the pre-trained models, the first pre-trained model associating a location of the terminal and the available bandwidth of the radio communication channel with each other, and
wherein the estimator estimates the available bandwidth of the radio communication channel using the first pre-trained model.

3. The bandwidth estimation apparatus according to claim 1,
wherein the trainer trains, through the pre-training, a second pre-trained model included in the pre-trained models, the second pre-trained model associating a reception level of the terminal and the available bandwidth of the radio communication channel with each other, and
wherein the estimator estimates the available bandwidth of the radio communication channel using the second pre-trained model.

4. The bandwidth estimation apparatus according to claim 2,
wherein the trainer trains, through the real-time training, a first real-time-trained model included in the real-time-trained models, the first real-time-trained model associating time and the location of the terminal with each other, and
wherein the estimator estimates the location of the terminal using the first real-time-trained model and estimates the available bandwidth of the radio communication channel using the estimated location and the first pre-trained model.

5. The bandwidth estimation apparatus according to claim 3,
wherein the trainer trains, through the real-time training, a second real-time-trained model included in the real-time-trained models, the second real-time-trained model associating time and the reception level of the terminal with each other, and
wherein the estimator estimates the reception level of the terminal using the second real-time-trained model and estimates the available bandwidth of the radio communication channel using the estimated reception level and the second pre-trained model.

6. The bandwidth estimation apparatus according to claim 1,
wherein the trainer trains, through the pre-training, a first pre-trained model included in the pre-trained models, the first pre-trained model associating a location of the terminal and the available bandwidth of the radio communication channel with each other, and a second pre-trained model included in the pre-trained models, the second pre-trained model associating a reception level of the terminal and the available bandwidth of the radio communication channel with each other, and trains, through the real-time training, a third real-time-trained model included in the real-time-trained models, the third real-time-trained model associating time and the available bandwidth of the radio communication channel with each other,
wherein the estimator estimates the available bandwidth of the radio communication channel using the first pre-trained model, estimates the available bandwidth of the radio communication channel using the second pre-trained model, and estimates the available bandwidth of the radio communication channel using the third real-time-trained model,
wherein the trainer trains, through the pre-training, a third pre-trained model included in the pre-trained models, the third pre-trained model associating the available bandwidth estimated using the third real-time-trained model, the available bandwidth estimated using the first pre-trained model, and the available bandwidth estimated using the second pre-trained model and the available bandwidth of the radio communication channel with each other, and
wherein the estimator estimates the available bandwidth of the radio communication channel using the third pre-trained model.

7. A method for estimating bandwidth, the method comprising:
training, through real-time training, real-time-trained models for estimating an available bandwidth of a radio communication channel through which a terminal performs radio communication;
training, through pre-training, pre-trained models for estimating the available bandwidth of the radio communication channel using a parameter relating to the radio communication performed by the terminal, the parameter being estimated from the real-time-trained models; and
estimating the available bandwidth of the radio communication channel using the pre-trained models.
